(19) United States
(12) Patent Application Publication
(10) Pub. No.: US 2014/0157776 A1
(43) Pub. Date: Jun. 12, 2014

(54) SOLAR ENERGY RECEIVER AND METHOD OF USING THE SAME

(71) Applicant: GENERAL ELECTRIC COMPANY, Schenectady, NY (US)

(72) Inventors: Sebastian Walter Freund, Unterfoehring (DE); Charles Michael Booth, Alpharetta, GA (US); Chiranjeev Singh Kalra, Niskayuna, NY (US)

(73) Assignee: GENERAL ELECTRIC COMPANY, Schenectady, NY (US)

(21) Appl. No.: 13/707,846

(22) Filed: Dec. 7, 2012

(51) Int. Cl. F03G 6/00; F24J 2/46; F24J 2/34; F24J 2/24

(52) U.S. Cl. CPC F03G 6/003; F24J 2/24; F24J 2/464; F24J 2/34
USPC 60/641.8; 126/651; 126/710; 126/663; 126/714

(57) ABSTRACT

A solar energy receiver includes a plurality of solar receiver elements. Each solar receiver element includes a substantially solid core configured to absorb solar radiation and to store the solar radiation as heat. The core includes a base surface and a plurality of absorption surfaces. The receiver further includes at least one fluid passageway defined within the core adjacent at least one absorption surface of the plurality of absorption surfaces, wherein the at least one fluid passageway is configured to channel a working fluid therethrough for absorbing heat stored in the core.

### BACKGROUND

The embodiments described herein relate generally to solar energy receivers and, more specifically, to a concentrated solar power receiver having integrated thermal storage.

The generation of electric power from thermal energy absorbed from solar radiation has been proposed as a complementary technological approach to the burning of fossil fuels, which may produce benefits, such as reduced emissions and reduced reliance on limited nonrenewable resources. Concentrated solar energy receivers provide one method of absorbing solar energy.

At least some known solar energy receivers incorporate a cavity having a small aperture through which concentrated radiation is focused from a field of reflectors. Such receivers typically use secondary mirrors for concentrating incoming solar energy. The receivers absorb the concentrated radiation and transfer the absorbed energy to a working fluid. The fluid is heated and used to heat an engine. The engine drives a generator, which produces electricity. However, such known receivers suffer a decreased efficiency due to thermal losses because of the shape of these receivers. Some receivers are manufactured from materials that pose limits on the operating temperature of the receiver. Moreover, known receivers lack availability of thermal mass and/or dedicated storage and accordingly, changes in radiation flux may cause rapid transients in temperature. Such drawbacks may lead to performance degradation in power cycle and/or cause thermal stresses in the receiver. In addition, a negative impact from sudden events, such as transients arising from cloud passage, sudden wind bursts, rain storms and/or other events may result in a temporary reduction in the levels of thermal energy flowing from a solar receiver to a downstream turbine system. In turn, a reduction in the levels of thermal energy may cause a decrease in power production.

### BRIEF DESCRIPTION

In one aspect, a solar energy receiver is provided. The solar energy receiver includes a plurality of solar receiver elements. Each solar receiver element includes a substantially solid core configured to absorb solar radiation and to store the solar radiation as heat. The core includes a base surface and a plurality of absorption surfaces. The receiver further includes at least one fluid passageway defined within the core adjacent at least one absorption surface of the plurality of absorption surfaces, wherein the at least one fluid passageway is configured to channel a working fluid through it for absorbing heat stored in the core.

In another aspect, a method of heating a working fluid in a solar receiver is provided. The method includes concentrating solar radiation on the solar receiver, wherein the solar receiver includes a plurality of solar receiver elements. Each solar receiver element of the plurality of solar receiver elements includes a substantially solid core having a plurality of absorption surfaces configured to absorb solar radiation and at least one fluid passageway defined within the core adjacent at least one absorption surface of the plurality of absorption surfaces. The method further includes channeling the working fluid through the at least one fluid passageway to expose the working fluid to heat absorbed by the plurality of absorption surfaces.

In yet another aspect, a power generation system is provided. The system includes a solar energy receiver, a turbine coupled downstream from the solar energy receiver, and a generator coupled to the turbine. The solar energy receiver includes a plurality of solar receiver elements. Each solar receiver element includes a substantially solid core configured to absorb solar radiation and to store the solar radiation as heat. The core includes a base surface and a plurality of absorption surfaces. The receiver further includes at least one fluid passageway defined within the core adjacent at least one absorption surface of the plurality of absorption surfaces, wherein the at least one fluid passageway is configured to channel a working fluid through it for absorbing heat stored in the core. The turbine is configured to use the heated working fluid from the solar energy receiver to produce rotational mechanical energy, and the generator is configured to produce electrical energy from the rotational mechanical energy.

### DRAWINGS

These and other features, aspects, and advantages of the present invention will become better understood when the following detailed description is read with reference to the accompanying drawings in which like characters represent like parts throughout the drawings, wherein:

FIG. 1 illustrates perspective cross-sectional view of an exemplary solar receiver.

FIG. 2 is a cross-sectional view of the exemplary solar receiver shown in FIG. 1.

FIG. 3 is a cross-sectional view of the exemplary solar receiver shown in FIG. 2 taken at line 3-3.

FIG. 4 is a simplified block diagram of an exemplary power generation system.

FIG. 5 is a flowchart illustrating an exemplary method for heating a working fluid using the solar receiver shown in FIGS. 1-3.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

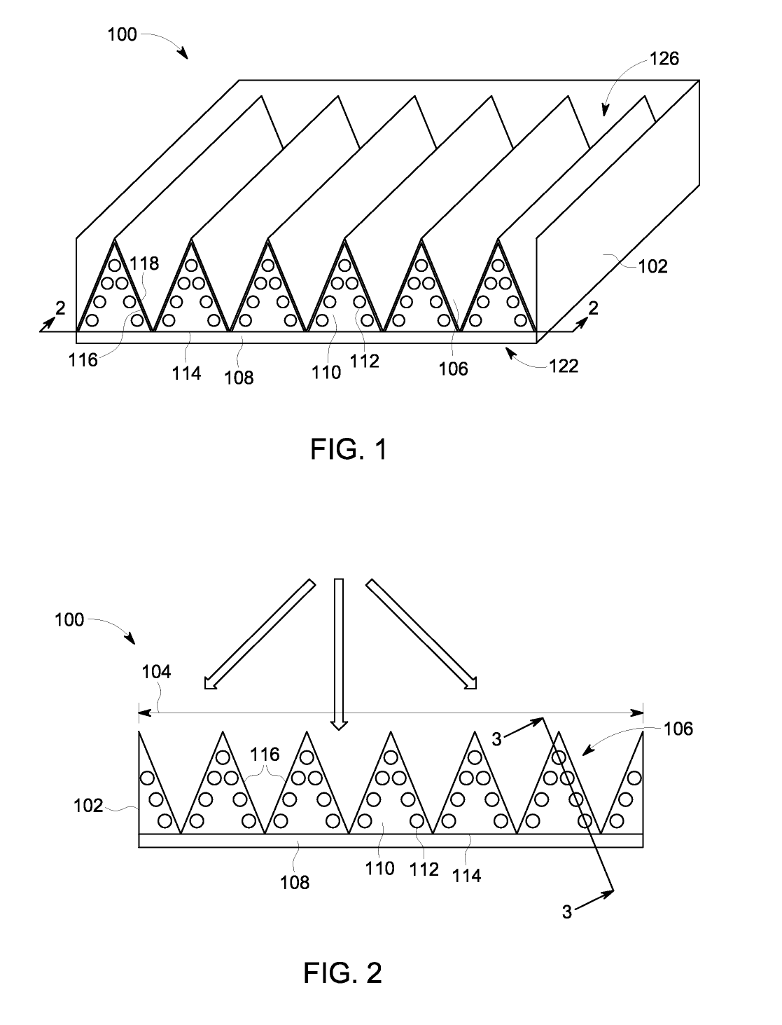

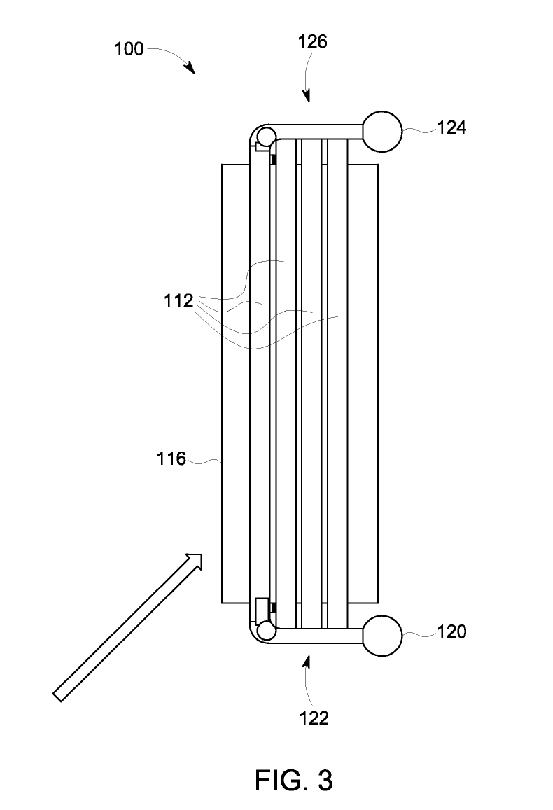

FIG. 1 illustrates a perspective cross-sectional view of an exemplary solar receiver 100. FIG. 2 is a cross-sectional view of the exemplary solar receiver shown in FIG. 1 taken at line 2-2. FIG. 3 is a cross-sectional view of the exemplary solar receiver shown in FIG. 2 taken at line 3-3.

Referring to FIGS. 1-3, in the exemplary embodiment, solar receiver 100 includes a housing 102 defining an aperture 104 on an open side of housing 102. Within housing 102, solar receiver 100 includes a plurality of solar receiver elements 106 coupled to a base 108 of solar receiver 100. Each solar receiver element 106 includes a core 110 and at least one fluid passageway 112 defined within core 110.

In the exemplary embodiment, core 110 is configured to absorb solar radiation and heat a working fluid flowing within solar receiver element 106. Moreover, core 110 is also configured to store absorbed thermal energy for short periods of time. Core 110 is generally triangular in cross-sectional shape and extends a length L of solar receiver 100. The triangular shape enables solar receiver 100 to trap concentrated light and reduce losses. Core 110 includes a base surface 114 coupled to base 108 and a plurality of absorption surfaces 116 extending from base surface 114 and configured to absorb incoming solar radiation.

Core 110 may be formed using various materials, including but not limited to, a substantially solid material, a solid state material, a liquid, a molten metal, and a phase-change material. For example, core 110 may be formed of solid state and other materials, such as high-temperature salts utilized in a phase-change context. In one embodiment, core 110 is substantially solid and formed using a thermal storage material having high thermal conductivity and thermal stability, for example, graphite. In some embodiments, core 110 includes a protective layer 118 made of a metal foil or sheet for protecting core 110 from long term exposure to the weather. Protective layer 118 is configured to absorb sunlight. Heat from the sunlight is transferred through protective layer 118 via conduction into the thermal storage material. The thermal storage material facilitates dampening fluctuations of the solar heat flux and the working fluid temperature by stabilizing the receiver temperature through storing and releasing heat in its heat capacity when the temperature changes. The amount of heat stored corresponds to several minutes of the heat flow transferred into the working fluid, enough to mitigate the impact of interruptions, for example, cloud transients, on the heating of the working fluid.

Fluid passageway as used herein may encompass any tube, pipe, conduit, or the like. In the exemplary embodiment, at least one fluid passageway 112 is defined within core 110 adjacent at least one absorption surface 116. Fluid passageway 112 is in thermal communication with absorption surface 116. More specifically, in the exemplary embodiment, fluid passageway 112 is a tube embedded within core 110 for channeling a working fluid to receive absorbed thermal energy stored in core 110. In the exemplary embodiment, fluid passageway 112 has a round cross-sectional shape. In alternative embodiments, fluid passageway 112 may have any configuration, for example, but not limited to, a polygonal cross-sectional shape, straight, bent, and/or curved. In some embodiments, a distribution header 120 is coupled to fluid passageway 112 at a first end 122 for receiving the working fluid to be heated. In this embodiment, a collection header 124 is coupled to fluid passageway 112 at a second end 126 of solar receiver 100 for channeling the heated working fluid exiting solar receiver 100. Fluid passageway 112 is capable of withstanding temperatures up to about 1000° C.

The geometry of solar receiver 100 is such that an actual surface area of solar receiver 100 is larger than a projected surface area perpendicular to concentrated light entering aperture 104. Such geometry tends to trap the light and increases efficiency of solar receiver 100, while reducing radiation flux density and surface temperature. Such geometry may be formed by arranging fluid passageways 112 in parallel along a wavy or rectangular line and forming core 110 both in front of and behind fluid passageways 112 relative to the direction of radiation. Fluid passageways are positioned near absorption surfaces 116 for increased exposure to incoming solar radiation. Base surfaces 114 of a plurality of solar receiver elements 106 are arranged adjacent to one another and are coupled to base 108 of solar receiver 100.

In the exemplary embodiment, solar receiver 100 may be elevated as a tower mounted receiver or may be located at ground level. If tower mounted, solar receiver 100 may be mounted atop a supporting tower having a height of about 15 m up to about 200 m, depend on the size (ground area) occupied by one or more heliostat fields. In an alternate embodiment, solar receiver 100 may be positioned at or near ground level. One or more fields of heliostats may reflect concentrated solar radiation to an elevated reflector that, in turn, redirects the solar radiation to solar receiver 100.

During operation, working fluid is channeled into fluid passageways 112 via distribution header 120. Solar radiation is reflected from a heliostat field onto solar receiver 100. The solar radiation entering aperture 104 is absorbed by at least one absorption surface 116 of solar receiver elements 106 and converted to heat. The heat may be stored in core 110 for a short period of time or may be transferred immediately to the working fluid flowing in fluid passageways 112. After the working fluid flows a length L through fluid passageways 112, it exits solar receiver 100 via collection header 124.

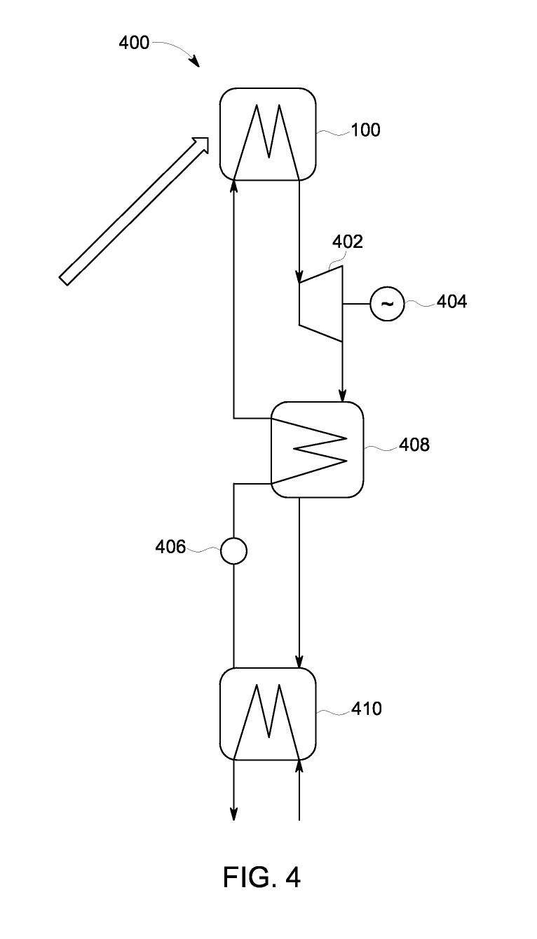

FIG. 4 illustrates an exemplary power generation system 400 in which solar receiver 100 (shown in FIGS. 1-3) may be used to heat a working fluid. In the exemplary embodiment, system 400 includes solar receiver 100 coupled to a turbine 402, which is coupled to a generator 404. A feed pump 406 is configured to provide compressed working fluid to solar receiver 100 to be heated. A recuperator 408 is coupled to an outlet portion of turbine 402 to recover the working fluid and delivers it either to a condenser 410 or back to solar receiver 100 to be reheated. While the exemplary embodiment is directed towards a turbine engine for power generation, the present invention is not limited to any one particular engine or application, and one of ordinary skill in the art will appreciate that the present invention may be used in a variety of other applications where a fluid is to be heated to a high temperature using concentrated solar radiation.

During operation, feed pump 406 channels compressed working fluid to solar receiver 100. As the compressed air flows through fluid passageway 112 (shown in FIGS. 1-3) of solar receiver 100, it is heated by solar radiation absorbed by core 110 (shown in FIGS. 1-3). Upon exiting solar receiver 100, the heated working fluid flows to turbine 402. Energy is transferred from the working fluid during expansion and converted to mechanical rotational energy by turbine 402. The mechanical rotational energy is then converted to electrical energy by generator 404. The lower temperature working fluid then flows to recuperator 408. Recuperator 408 may either channel the working fluid to a condenser 410 to be used as a cooling fluid or back to solar receiver 100 to be reheated to drive turbine 402.

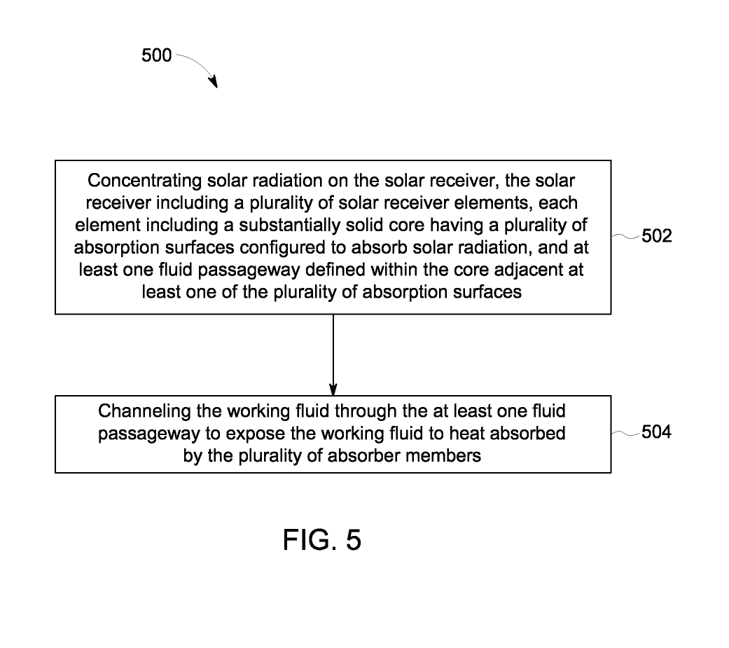

FIG. 5 is a flowchart 500 illustrating an exemplary method of heating a working fluid in a solar receiver, for example, solar receiver 100 (shown in FIGS. 1-3). In the exemplary embodiment, the method includes concentrating 502 solar radiation on solar receiver 100, wherein solar receiver 100 includes a plurality of solar receiver elements 106, each solar receiver element 106 of the plurality of solar receiver elements 106 including a substantially solid core 110 having a plurality of absorption surfaces 116 configured to absorb solar radiation. Solar receiver element 106 also includes at least one fluid passageway 112 defined within core 110 adjacent at least one absorption surface 116 of the plurality of absorption surfaces 116.

Concentrating 502 solar radiation on solar receiver 100 may include configuring a plurality of heliostats (not shown) to direct solar radiation towards solar receiver 100 and absorbing the solar radiation by absorption surfaces 116.

In the exemplary embodiment, the method further includes channeling 504 the working fluid through the at least one fluid passageway 112 to expose the working fluid to heat absorbed by the plurality of absorption surfaces 116.

The exemplary solar receiver systems and methods of using the same described herein provide a solar energy receiver that may be used for heating a working fluid to a high temperature. The description enables one of ordinary skill in the art to make and use the disclosure, and includes descriptions of several exemplary embodiments. However, the disclosure is not limited to heating a fluid in a turbine engine as described herein, but may be used to heat fluid in any application that includes heating a fluid to a high temperature using solar radiation. The embodiments described herein enable short-term, highly-efficient heat storage in a solar receiver without added complexity by providing a cavity-effect without requiring expensive high-temperature windows used in other cavity receiver designs. Additionally, by embedding fluid passageways into a thermal storage material of good thermal conductivity, mechanical problems in tubular receivers due to one-sided heat flux and high thermal gradients and resulting excessive stresses can be mitigated.

An exemplary technical effect of the methods, systems, and apparatus described herein includes at least one of: (a) providing a passive method to defeat (or dampen) a negative impact of sudden events that can result in a temporary reduction in the level of thermal energy flowing from a solar receiver to a downstream turbine system; and (b) mitigating transients arising from cloud passage, sudden wind bursts, rain storms, and/or other events by having an integrated thermal storage capability within the context of the receiver that can, on a temporary basis, give up energy to compensate for the reduced rate of transmission to the receiver because of the transients.

Exemplary embodiments of solar energy receivers are described above in detail. The solar receivers and methods of using the same are not limited to the specific embodiments described herein, but rather, components of systems and/or steps of the methods may be utilized independently and separately from other components and/or steps described herein. For example, the methods may also be used in combination with other solar energy receiving systems and methods, and are not limited to practice with only the concentrated solar energy receivers and methods of using the same, as is described herein. Rather, the exemplary embodiment can be implemented and utilized in connection with many solar receiver applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A solar energy receiver comprising:
a plurality of solar receiver elements, each solar receiver element comprising:
a core configured to absorb solar radiation and to store the solar radiation as heat, said core comprising a base surface and a plurality of absorption surfaces; and
at least one fluid passageway defined within said core adjacent at least one absorption surface of said plurality of absorption surfaces, said at least one fluid passageway configured to channel a working fluid therethrough for absorbing heat stored in said core.

2. A solar energy receiver in accordance with claim 1, wherein said at least one fluid passageway is in thermal communication with said at least one absorption surface.

3. A solar energy receiver in accordance with claim 1, wherein said core has a generally triangular cross-sectional shape.

4. A solar energy receiver in accordance with claim 1, wherein said core comprises a thermal storage material configured to store absorbed solar radiation as heat.

5. A solar energy receiver in accordance with claim 4, wherein said thermal storage material is configured to stabilize a temperature of the working fluid when the solar radiation fluctuates.

6. A solar energy receiver in accordance with claim 4, wherein said core comprises at least one of a substantially solid material, a solid state material, a liquid, and a phase-change material.

7. A solar energy receiver in accordance with claim 4, wherein heat is transferred from the thermal storage material along a temperature gradient to said at least one fluid passageway.

8. A solar energy receiver in accordance with claim 1, wherein each said solar receiver element further comprises a protective layer comprising a metal foil.

9. A solar energy receiver in accordance with claim 1, wherein said each solar receiver element comprises a plurality of fluid passageways, wherein the plurality of fluid passageways are positioned parallel to one another.

10. A solar energy receiver in accordance with claim 1, wherein said at least one fluid passageway is capable of withstanding temperatures up to about 1000° C.

11. A solar energy receiver in accordance with claim 1, wherein said at least one fluid passageway comprises a tube embedded in the core.

12. A solar energy receiver in accordance with claim 1, wherein an actual surface area of said solar receiver is larger than a projected surface area perpendicular to concentrated light entering said solar receiver.

13. A solar energy receiver in accordance with claim 1, further comprising a distribution header coupled to said at least one fluid passageway at a first end for introducing a flow of working fluid into said solar energy receiver.

14. A solar energy receiver in accordance with claim 13, wherein said each solar receiver element further comprises a distribution header coupled to said at least one fluid passageway at a second end for channeling the heated working fluid exiting said solar energy receiver.

15. A solar energy receiver in accordance with claim 1, wherein the working fluid comprises one of water and carbon dioxide.

16. A solar energy receiver in accordance with claim 1, wherein a temperature of said core is controlled by regulating a flow of the working fluid through said at least one fluid passageway.

17. A method of heating a working fluid in a solar receiver, said method comprising:
concentrating solar radiation on the solar receiver, the solar receiver including a plurality of solar receiver elements, each solar receiver element of the plurality of solar receiver elements including a substantially solid core having a plurality of absorption surfaces configured to absorb solar radiation and at least one fluid passageway defined within the core adjacent at least one absorption surface of the plurality of absorption surfaces; and
channeling the working fluid through the at least one fluid passageway to expose the working fluid to heat absorbed by the plurality of absorption surfaces.

18. A method in accordance with claim 17, wherein concentrating solar radiation on the solar receiver further comprises:
configuring a plurality of heliostats to direct solar radiation towards the solar receiver; and
absorbing the directed solar radiation by the plurality of absorption surfaces.

19. A power generation system comprising:
a solar energy receiver comprising a plurality of solar receiver elements, each solar receiver element comprising:
a substantially solid core configured to absorb solar radiation and to store the solar radiation as heat, said core comprising a base surface and a plurality of absorption surfaces; and
at least one fluid passageway defined within said core adjacent at least one absorption surface of said plurality of absorption surfaces, said at least one fluid passageway configured to channel a working fluid therethrough for absorbing heat stored in said core;
a turbine coupled downstream from said solar energy receiver and configured to use the heated working fluid from said solar energy receiver to produce rotational mechanical energy; and
a generator coupled to said turbine and configured to produce electrical energy from the rotational mechanical energy.

20. A power generation system in accordance with claim 19, wherein said core comprises a thermal storage material configured to store absorbed solar radiation as heat.
